(19) United States
(12) Patent Application Publication
(10) Pub. No.: US 2003/0143451 A1
(43) Pub. Date: Jul. 31, 2003

(54) Fuel cell metallic seperator and method for manufacturing same

(75) Inventors: Keisuke Andou, Saitama (JP); Naoyuki Enjoji, Saitama (JP); Hideaki Kikuchi, Saitama (JP); Tadashi Nishiyama, Saitama (JP); Mikihiko Kimura, Saitama (JP); Shinya Kawachi, Saitama (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: HONDA GIKEN KOGYO KABUSHIKI KAISHA

(21) Appl. No.: 10/352,958

(22) Filed: Jan. 29, 2003

(30) Foreign Application Priority Data
Jan. 31, 2002 (JP) P. 2002-022698

(51) Int. Cl. H01M 8/02; H01M 2/08; B05D 5/12

(52) U.S. Cl. 429/34; 429/26; 429/38; 429/36; 427/115

(57) ABSTRACT

A fuel cell metallic separator adapted to constitute a partition wall between single cells for a fuel cell stack, includes a metallic plate and a resin portion made of a thermoplastic or thermosetting resin. At least either upper and lower peripheral edge portions or left and right peripheral edge portions of the metallic plate are integrally formed with the resin portion. The metallic plate is provided with a passage for fuel gas, oxide gas or coolant for a fuel cell and the resin portion has communication ports provided for allowing fuel gas, oxide gas or coolant to pass therethrough. The metallic plate and the resin portion are formed integrally through injection molding.

### BACKGROUND OF THE INVENTION

1. Field of the Invention

The present invention relates to a fuel cell metallic separator and a method for manufacturing the same, and more particularly to a fuel cell metallic separator which has superior corrosion resistance, which can relatively easily deal with complicated configurations and which can enable the reduction in size and weight and a method for manufacturing the same which can reduce the number of manufacturing steps.

2. Description of the Related Art

A fuel cell generates electricity by supplying fuel gas containing hydrogen to a hydrogen electrode of the fuel cell and oxide gas containing oxygen to an oxygen electrode of the fuel cell. A fuel cell like this attracts attention to its high electricity generating efficiency and extremely low emissions of pollutant matters which result from the direct conversion of chemical energy into electric energy.

Raised as a conventional fuel cell is a fuel cell stack, as shown in FIG. 12A, including several hundreds of single cells each including, as shown in FIG. 12B, an air-side separator SA, a hydrogen-side separator SH and a membrane electrode assembly MEA. The air-side separator SA and the hydrogen-side separator SH are each constructed to separate fuel gas, oxide gas and coolant such as cooling water of a fuel cell from those of another fuel cell, and communication ports are provided in the separators for allowing fuel gas, oxide gas or coolant to pass therethrough for communication between the fuel cells, the communication ports in the separators which are disposed adjacent to each other via the membrane electrode assembly MEA being interposed therebetween being made to communicate with each other. Furthermore, provided in the separators are fuel gas passages and oxide gas passages for guiding fuel gas and oxide gas, respectively, into the interior of the membrane electrode assembly MEA, as well as coolant passages for guiding coolant to the membrane electrode assembly for cooling the fuel gas and oxide gas.

Note that the air passages are provided on the outside of the oxygen electrode for allowing air as oxide gas to flow therethrough to the oxygen electrode and that the hydrogen gas passage are provided on the outside of the hydrogen electrode for allowing hydrogen gas as fuel gas to flow therethrough to the hydrogen electrode. Then, entrances and exits of the air passages are connected to an air supply device, not shown, and entrances and exists of the hydrogen gas passages are connected to a hydrogen supply device.

In addition, provided in the membrane electrode assembly MEA are electrode catalyst layers C including a pair of oxygen electrode (cathode electrode) and hydrogen electrode (anode electrode) disposed to face each other with a polymer electrolyte membrane M being held therebetween. An oxygen electrode-side gas diffusion layer D and a hydrogen electrode-side gas diffusion layer D are provided on the oxygen electrode and the hydrogen electrodes respectively.

Then, the gas diffusion layers D are provided in such a manner as to be brought into contact with the air passages and the hydrogen gas passages formed in the surfaces of the air-side separator SA and the hydrogen-side separator SH, respectively, and have a function to allow electrons to be transferred between the electrode catalyst layer C and the air-side separator SA or the electrode catalyst layer C and the hydrogen-side separator SH and a function to diffuse hydrogen gas and air at the respective layers, and are generally formed of carbon fibers.

As has been described heretofore, the air-side separator SA and the hydrogen-side separator SH have the function to separate fuel gas (hydrogen gas), oxide gas (air) and coolant (cooling water) into the fuel cell, include the hydrogen gas passage, the air passage and the coolant passage, and further have the electron transfer function. This requires the fuel cell separators to have good electricity conductivity and gas impermeability. Furthermore, in recent years, the fuel cell separators are additionally required to have high strength and lightness in weight or economical efficiency.

Incidentally, while hydrogen gas and oxygen gas react on the cathode electrode side to produce water when the fuel cell is in operation, in a low-temperature type fuel cell provided with the aforesaid polymer electrolyte membrane M (FIG. 12B), since water so produced is mixed with off-gas, water tends to stay in the interior of the communication ports of the separators provided on the fuel cell. Due to this, in a case where the fuel cell separators are constituted by metallic plates, there occurs a short-circuit (liquid communication) between a structure which supports the fuel cell and the metallic plates, and the occurrence of electrolytic corrosion is facilitated. The electrolytic corrosion is easy to occur, in particular, at edge portions of the metallic plates, and in the event that communication ports are formed by making use of openings in the metallic plates, edge portions of the openings tend to get corroded. With a view to restraining the occurrence of electrolytic corrosion like this, conventionally, for example, the following fuel cell separators have been proposed.

JP-A-60-24656 proposes a fuel cell separator formed by filling a die having a predetermined configuration with a mixture comprising carbon powder and phenolic resin added as a binder, heating the mixture so filled in the die at a temperature at which no graphitization is caused and pressing the same.

In addition, JP-A-8-222241 proposes a fuel cell separator formed by kneading carbon power and phenolic resin added there into as a binder together to form a mixture, and machining a graphite material obtained after sintering and graphitization treatments have been applied to the mixture, into a desired shape.

Furthermore, JP-A-10-125337 proposes a fuel cell separator formed by applying fluorine plastic or nylon to an expanded graphite sheet or impregnating an expanded graphite sheet with fluorine plastic or nylon and processing the fluorine plastic or nylon applied or impregnated expanded graphite sheet with a die or roll having a predetermined configuration.

With the conventional fuel cell separators using carbon materials and methods for manufacturing those separators, the material cost and the processing or treating cost are expensive, and therefore, these expensive costs have mainly prevented the fuel cell separators using carbon materials from being put in a practical use.

On the other hand, while metallic materials can be used which are produced by gold plating metallic materials such as stainless steel or titanium having superior corrosion resistance, these materials have been disadvantageous in lightness in weight and workability.

In addition, in case pin holes are produced in a plated layer when the metallic materials are plated, there has been caused a problem that the corrosion resistance is deteriorated.

Then, with a view to solving the problems inherent in the metallic materials, JP-A-11-129396 proposes a fuel cell separator made of a composite material of metal and silicone resin in which a metallic plate is totally coated with silicone resin.

With the fuel cell separator made of the composite material of metal and silicone resin, however, the thickness of the fuel cell separator is increased by the thickness of the silicone resin coated over the metallic plate, leading to a problem that the stacked construction of the fuel cell separators is enlarged.

### SUMMARY OF THE INVENTION

With a view to solving the problems, an object of the invention is to provide a fuel cell separator in which a metallic plate and resin are integrally formed without any increase in thickness to thereby improve the corrosion resistance of the metallic plate and which is provided with a rib portion for holding the air-tightness between single cells, and a method for manufacturing the same fuel cell separator at low cost.

With a view to solving the problems, according to the a first aspect of the invention, there is provided a fuel cell metallic separator constituting a partition wall between single cells of a fuel cell stack and having at least one communication port for allowing fuel gas, oxide gas or coolant to pass therethrough for communication between the single cells, wherein a resin portion made of resin is integrally formed on a metallic plate in such a manner as to overlap at least part of edge portions of the metallic plate or in such a manner that a seal material is interposed therebetween, and wherein the at least one communication port is provided in the resin portion.

According to this construction, since the metallic plate and the resin portion are formed integrally in such a manner that at least part of the edge portions of the metallic plate overlap the resin portion in which the communication ports are formed, or in such a manner that the seal material is interposed between the metallic plate and the resin portion, there is embodied without any increase in thickness a fuel cell separator which has improved corrosion resistance against the fuel gas, oxide gas or coolant.

In particular, according to the invention of the first aspect, since the edge portions of the metallic plate which is included in the fuel cell metallic separator are protected by the resin portion, and since the communication ports are formed in the resin portion, there can be provided a special advantage that an electrolytic corrosion can effectively be prevented that would otherwise be caused by a short-circuit (liquid communication) caused between the structure which supports the fuel cell and the metallic plate through water staying in the interior of the communication ports in the resin portion.

In addition, according to a second aspect of the invention, there is provided a fuel cell metallic separator, wherein a rib portion constituted by a seal member is formed around the communication ports provided in the resin portion through injection molding.

With this construction, since the rib portion for holding the air-tightness between the single cells of the fuel cell stack is formed on the metallic plate and the resin portion through injection molding, the manufacturing processes are simplified, whereby there is embodied a fuel cell metallic separator which can produced with reduced costs.

Additionally, according to a third aspect of the invention, the resin portion is made of a thermoplastic resin.

With this construction, since the moldability of the resin portion can be improved, there is embodied a fuel cell metallic separator can be embodied which can easily deal with relatively complicated configurations.

Furthermore, according to a fourth aspect of the invention, the resin portion can be made of polyphenylene sulfide or liquid crystal polymer.

With this construction, there is embodied a fuel cell metallic separator in which in addition to further improvement in moldability of the resin portion, the heat resistance, chemical resistance and insulation properties of the resin portion can further be increased.

Additionally, according to the fifth aspect of the invention, the resin portion maybe made of a thermosetting resin.

With this construction, there is embodied a fuel cell metallic separator in which the heat resistance of the resin portion is further increased.

Furthermore, according to a sixth aspect of the invention, the resin portion can also be made of phenolic resin or epoxy resin.

According to the construction, there is embodied a fuel cell metallic separator in which the heat resistance, chemical resistance, adhesion and costs of the resin portion are balanced.

Additionally, with a view to solving the problems, according to a seventh aspect of the invention, there is provided a method for manufacturing a fuel cell metallic separator as set forth in the second aspect, including the steps of (a1) setting the metallic plate in a resin portion molding die, and injecting a resin into the die so as to integrally form a resin portion having the communication ports on the metallic plate to thereby form a metal-resin composite plate, (a2) applying a resin for forming a primer layer around the communication ports in the metal-resin composite plate so as to form a primer layer, and (a3) setting the metal-resin composite plate on which the primer layer is formed in a rib molding die and injecting a seal material on the primer layer so as to form a rib portion.

In the (a2) step of applying the resin for forming a primer layer around the communication ports in the metal-resin composite plate so as to form the primer layer, the resin for forming a primer layer can be applied by spraying the same resin with a nozzle provided on the resin portion molding die.

According to this method, since the metallic plate and the resin portion can be formed integrally relatively easily without any increase in thickness through injection molding, there is embodied a method for manufacturing a fuel cell metallic separator with which a fuel cell metallic separator which is thin in shape and which has an increased corrosion resistance can be produced while suppressing an increase in cost.

In addition, according to an eighth aspect of the invention, there is provided a method for manufacturing a fuel cell metallic separator as set forth in claim 2, comprising the steps of (b1) forming a resin portion having the communicating ports, and (b2) setting the metallic plate and the resin portion in a seal molding die in such a manner that edge portions of the metallic plate overlap the resin portion and injecting a seal material so as to form a rib portion to thereby seal and join together portions where the edge portions of the metallic plate and the resin portion overlap each other.

With this method, since the frame-like resin portion is prepared in advance separately and the metallic plate and the resin portion can be formed integrally relatively easily without any increase in thickness, there is embodied a method for manufacturing a fuel cell metallic separator with which a fuel cell metallic separator which is thin in shape and which has the improved corrosion resistance can be produced while the number of steps is reduced.

In addition, according to a ninth aspect of the invention, there is provided a method for manufacturing a fuel cell metallic separator as set forth above, wherein the resin portion can be made of a thermoplastic resin.

With this method, there is embodied a method for manufacturing a fuel cell metallic separator with which the moldability of the mold portion can be increased.

Furthermore, according to a tenth aspect of the invention, there is provided a method for manufacturing a fuel cell metallic separator as set forth above, wherein the resin portion is formed of polyphenylene sulfide or liquid crystal polymer.

With this method, there is embodied a method for manufacturing a fuel cell metallic separator with which in addition to the further increase in moldability of the resin portion, the heat resistance, chemical resistance and insulation properties of the resin portion can further be increased.

Additionally, according to an eleventh aspect of the invention, there is provided a method for manufacturing a fuel cell metallic separator as set forth above, wherein the resin portion may be formed of a thermosetting resin.

With this method, there is embodied a method for manufacturing a fuel cell metallic separator with which the heat resistance of the resin portion can further be increased.

Furthermore, according to a twelfth aspect of the invention, there is provided a method for manufacturing a fuel cell metallic separator as set forth above, wherein the resin portion may be formed of phenolic resin or epoxy resin.

With this method, there is embodied a method for manufacturing a fuel cell metallic separator with which the heat resistance, chemical resistance, adhesion and costs of the resin portion are balanced.

### BRIEF DESCRIPTION OF THE DRAWINGS

FIGS. 1A and 1B are typical drawings partially showing the construction of a fuel cell metallic separator of a first embodiment according to the invention, FIG. 1A being a plan view, FIG. 1B being a sectional view taken along the line A-A in FIG. 1A;

FIG. 2 is a typical sectional view showing the construction of an injection molding die for use in preparing the fuel cell metallic separator according to the first embodiment shown in FIG. 1 and a fuel cell metallic separator according to a second embodiment shown in FIG. 3;

FIGS. 3A and 3B are typical drawings partially showing the construction of a fuel cell metallic separator of a second embodiment according to the invention, FIG. 3A being a plan view, FIG. 3B being a sectional view taken along the line B-B in FIG. 3A;

FIGS. 4A and 4B are typical drawings partially showing the construction of a fuel cell metallic separator of a third embodiment according to the invention, FIG. 4A being a plan view, FIG. 4B being a sectional view taken along the line C-C in FIG. 4A;

FIG. 5 is a typical sectional view showing the construction of an injection molding die for use in preparing the fuel cell metallic separator according to the third embodiment shown in FIG. 4;

FIGS. 6A and 6B are typical drawings partially showing the construction of a fuel cell metallic separator of a fourth embodiment according to the invention, FIG. 6A being a plan view, FIG. 6B being a sectional view taken along the line D-D in FIG. 6A;

FIG. 7 is a typical sectional view showing the construction of an injection molding die for use in preparing the fuel cell metallic separator according to the fourth embodiment shown in FIG. 6;

FIGS. 8A and 8B are typical drawings partially showing the construction of a fuel cell metallic separator of a fifth embodiment according to the invention, FIG. 8A being a plan view, FIG. 8B being a sectional view taken along the line D-D in FIG. 8A;

FIG. 9 is a typical sectional view showing the construction of an injection molding die for use in preparing the fuel cell metallic separator according to the fifth embodiment shown in FIG. 8.

FIG. 10 is an example of flow of processes of manufacturing the fuel cell metallic separators according to the invention;

FIG. 11 is another example of flow of processes of manufacturing the fuel cell metallic separators according to the invention; and

FIGS. 12A and 12B are typical drawing showing the exemplified construction of a conventional fuel cell stack and a single cell thereof, FIG. 12A showing the stacked structure of the fuel cell stack, FIG. 12B showing the single cell contained in the fuel cell stacked structure.

### DETAILED DESCRIPTION OF THE PREFERRED EMBODIMENTS

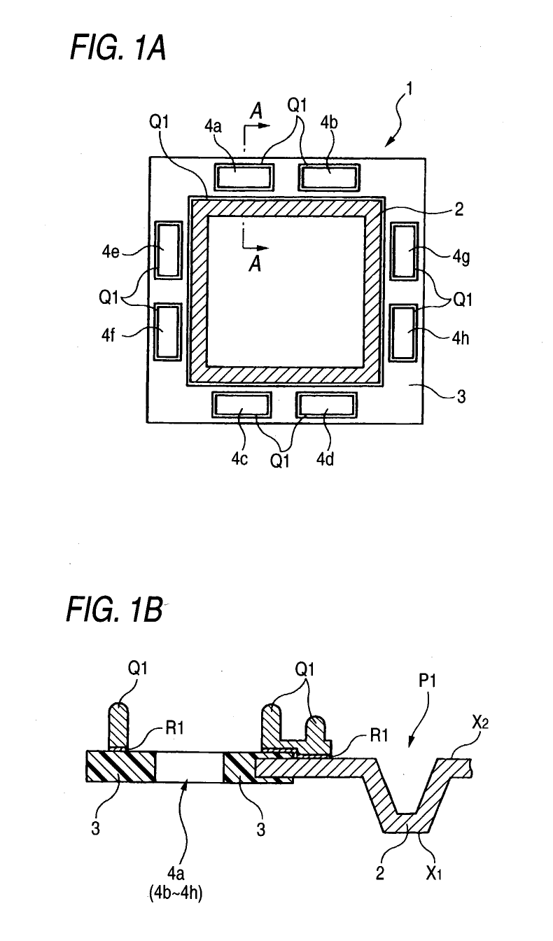

Next, a mode for carrying out a fuel cell metallic separator according to the invention will be described in detail. As an example is shown in FIGS. 1A, 1B, the invention provides a fuel cell metallic separator 1 in which a resin portion 3 is integrally formed on part of edge portions of a metallic plate 2, communication ports are provided in the resin portion 3 for allowing fuel gas, oxide gas or coolant of a fuel cell to pass therethrough, and a rib portion Q1 is provided on the metallic plate 2 and the resin portion 3 as an airtight seal. In addition, preferably, a primer layer R1 is provided between the metallic plate 2 and the resin portion 3 and the rib portion Q1 in order to increase adhesion propertied between the metallic plate 2 and the resin portion 3 and the rib portion Q1. Conditions required by the construction of the invention will be described below.

A resin forming the resin portion of the fuel cell metallic separator according to the invention needs to be stable against the fuel gas, oxide gas and various types of coolant including cooling water and to be provided with a required heat resistance (for example, a heat resistance temperature after molded: 80° C. or higher). Furthermore, the resin needs to have a suitable fluidity at a predetermined temperature so that the resin portion can be formed into a desired shape when the resin is formed integrally with the metallic plate through injection molding. Further, the resin needs to be provided with a certain flexibility which allows the resin to follow the expansion or contraction of the metallic plate so as not to be separated from the metallic plate while the fuel cell is in use.

Raised as the aforesaid resin are conventional thermoplastic resins such as polyphenylenesulfide (PPS), liquid crystal polymer, methacrylic resin and nylon 6 or conventional thermosetting resins such as phenolic resin, epoxy resin and various types of non-saturated polyester resin.

In case the resin portion is formed of, for example, a thermoplastic resin such as polyphenylene sulfide (PPS) or liquid crystal polymer, there is embodied a fuel cell metallic separator which can deal with relatively complicated shapes with increased moldability of the resin portion. In addition, in case the resin portion is formed of, for example, a thermosetting resin such as phenolic resin or epoxy resin, there is embodied a fuel cell metallic separator in which the heat resistance, chemical resistance and insulation properties of the resin portion can be increased and which can satisfy the requirement for costs.

In addition, in a case where the durability of the fuel cell metallic separator according to the invention needs to be increased further, it is preferable to use a thermosetting resin, and in particular, in order to increase the heat resistance, chemical resistance and adhesion of the resin portion and to satisfy the requirement for cost, it is preferable that the resin portion is formed of phenolic resin or epoxy resin.

[Metallic Plate]

As to metallic plates for use in the invention, any metallic plates can be used provided that even if thinned, the plates can still secure a required strength and provide a superior heat resistance and can continue to be chemically stable against the fuel gas, oxide gas or coolant.

Raised as the metallic plates described above are conventionally known various types of sheet steel (such as SPCC or the like regulated under JIS G 3141), sheet stainless steel (SUS430, SUS304 or the like regulated under JIS G 4305), titanium (for example, JIS 2^{nd} class pure titanium), aluminum (1000 system regulated under JIS H 4000) or aluminum-alloy (for example, 5000 system alloy of Al—Mn system regulated under JIS H 4100). In a case where a sheet steel is used for the metallic plate, it is preferable to conventionally known various types of plating treatments may be applied to impart a desired corrosion resistance.

In addition, according to the invention, since the resin portion is integrally formed so as to overlap at least part of the edge portion of the metallic plate, the corrosion of the metallic plate is effectively restrained. Due to this, according to the invention, even in case a metallic plate is used which is lower in corrosion resistance than a metallic plate contained in the conventional fuel cell metallic separator, there can be embodied a fuel cell metallic separator having a corrosion resistance which is equal to or greater than that of the conventional fuel cell metallic separator.

[Rib Portion]

The fuel cell metallic separator according to the invention is such as to constitute a partition wall that is to be disposed between single cells of a fuel cell stack, and in order to hold air-tightness between the single cells, the rib portion Q1 is disposed around, for example, as shown in FIG. 1B, the peripheral portions of the respective passages P1 provided in such a manner as to penetrate the resin portion for the fuel gas, oxide gas or coolant, or, as shown in FIGS. 1A, 1B, the peripheral portions of the communication ports 4a-4h provided for allowing those gases or coolant to pass therethrough.

In addition, this rib portion also functions to seal and join together portions where the metallic plate 2 and the resin portion 3 overlap each other.

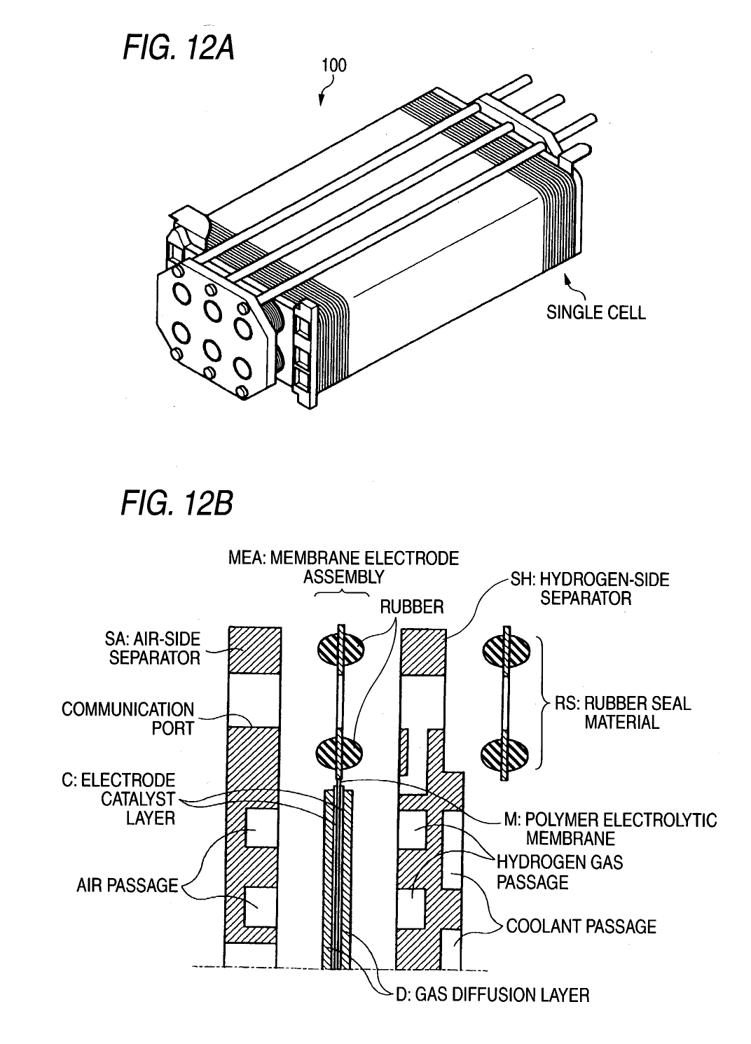

The rib portion Q1 needs to have a durability which is good enough to secure suitable air-tightness for preventing a leakage of those gases such as hydrogen gas in the interior of the fuel cell stack (FIG. 12A) under high-temperature conditions or highly-acid conditions that would result at the membrane electrode assembly MEA and conditions that would result at the cooling portion where the various types of coolant such as cooling water are allowed to flow.

In the invention, there is no specific limitation to seal materials which form the rib portion, and therefore, any seal material can be used provided that it can not only provide required gas impermeability, heat resistance, durability and suitable elasticity but also be injection molded to form the resin portion. Raised as a seal material like this is, for example, silicone resin. As to this silicone resin, there are normal addition-type liquid silicone resins which are liquid silicone resins, and among them, for example, two-part type liquid silicone resins can be used. Among them, in particular, those are preferred whose viscosity ranges 10³ to 10⁴ poise (at 25° C). In addition, fine powdered silica, high heat conductive inorganic filler and the like may be added to this silicone resin as required.

In this invention, conditions when injecting a silicone resin like this into an injection molding die can be suitably determined on condition that there is produced no bubble. For example, the temperature of the die can be set to range from 100° C. to 300° C., and the injection pressure for silicone resin with the die's temperature being in that range can also be set to range from 15 MPa to 20 MPa (150 to 200 kgf/cm²)

Furthermore, in the invention, in order to secure an appropriate adhesion between the rib portion and the metallic plate and resin portion, preferably a primer layer is provided on the metallic plate or the resin portion at portions where the rib portion is provided and edge portions of those portions.

[Primer Layer]

There is no specific limitation to a primer layer of the invention, and any type of primer layer can be used provided that it can provide good application properties (including application through spraying) relative to both the metallic portion and the resin portion and good adhesion to the seal material forming the rib portion, and can suitably hold the air-tightness between single cells. It is desired that a primer layer like this has an appropriate elasticity, and, for example, the primer layer can be constituted by a silicone resin system primer or a silane system primer.

Next, the invention will be described in detail based on first to fifth embodiments.

Note that in the following description, like reference numerals are imparted to members having the same construction.

(First Embodiment)

FIGS. 1A and 1B are typical drawings partially showing the construction of a fuel cell metallic separator according to a first embodiment of the invention, in which FIG. 1A is a plan view and FIG. 1B is a sectional view taken along the line A-A in FIG. 1A.

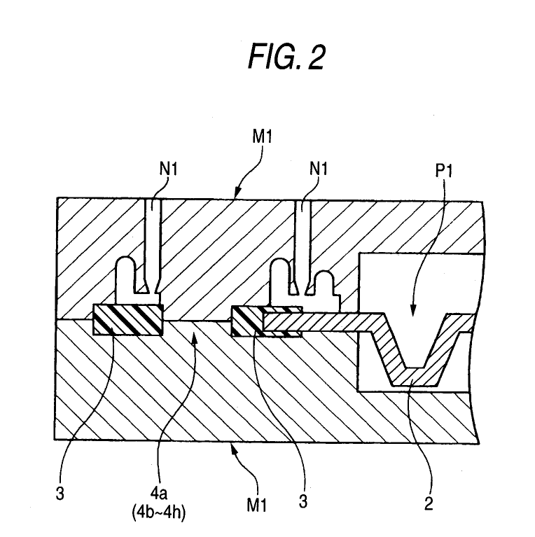

In addition, FIG. 2 is a schematic view showing manufacturing processes of the fuel cell metallic separator according to the first embodiment of the invention including the processes of forming integrally a metallic plate and a resin portion and continuously forming a primer layer and a rib portion at predetermined portions of where the metallic plate and the resin portion are integrally formed.

As shown in FIG. 1A, a fuel cell metallic separator 1 of the first embodiment according to the invention has a resin portion 3 constituted by a frame-like resin which is formed at upper and lower, and left and right edge portions of a metallic plate 2, and the metallic plate 2 and the resin portion 3 are formed integrally. This fuel cell metallic separator 1 according to the first embodiment is such as to constitute partition walls between single cells contained in the fuel cell stack 100 shown in FIG. 12A and corresponds to the air-side separator SA and the hydrogen-side separator SH shown in FIG. 12B.

As shown in FIG. 1B, the metallic plate 2 contained in the fuel cell separator 1 according to the first embodiment is provided with respective passages P1 for fuel gas, oxide gas or coolant for a fuel cell. In addition, as shown in FIG. 1A, the resin portion 3 is provided with communication ports 4a, 4b, 4c, 4d, 4e, 4f, 4g, 4h for allowing the fuel gas, oxide gas or coolant to pass therethrough. Thus, according to the invention, since the communication ports for allowing the fuel gas, oxide gas or coolant to pass therethrough are formed of resin and the edge portions of the metallic plate 2 which tend to be a root cause of corrosion are protected with the resin, even if water stays in the interior of the communication ports to thereby cause a short-circuit (liquid communication) between a structure which supports the fuel cell and the metallic plate contained in the fuel cell metallic separator, electrolytic corrosion of the metallic plate 2 is designed to be prevented as much as possible.

In addition, as shown in FIG. 1B, with the fuel cell metallic separator 1 according to the first embodiment of the invention, the metallic plate 2 and the resin portion 3 are integrally formed without an increase in thickness. Namely, in the invention, the fuel cell metallic separator 1 is formed such that the thickness of the resin portion 3 is made thinner than a vertical distance between an external portion X1 of a bottom of the passage P1 formed in the metallic plate 2 and a top portion X2 of the passage P1 (here, this distance is referred to as the “width of the metallic plate 2”). Thus, in the fuel cell metallic plate according to the invention, since the metallic plate 2 and the resin portion 3 are integrally formed such that the thickness of the resin portion 3 does not exceed the width of the metallic plate 2, a high corrosion resistance can be obtained without an increase in thickness. Furthermore, as shown in FIG. 1B, a rib portion Q1 formed of a seal material is provided as a partition at portions in the vicinity of the passage 1 provided on the metallic plate 2 and the communication ports 4a to 4h formed in the resin portion 3 to secure air-tightness, so that fuel gas, oxide gas or coolant can be supplied to each single cell without any leakage thereof. In the invention, it is preferable that a primer layer R1 is provided between the rib portion Q1 and the metallic plate 2 and resin portion 3 in order to increase the adhesion and adhesive quality therebetween. In the invention, a process of forming the metallic plate 2 and the resin portion 3 integrally and a process of forming the primer layer R1 and the rib portion Q1 are designed to take place continuously through injection molding. Consequently, according to the invention, the fuel cell metallic separator having a superior corrosion resistance can be manufactured without any increase in thickness and, moreover, with suppressed cost.

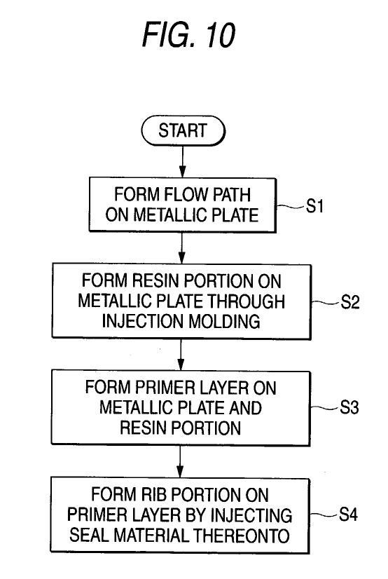

Note that the fuel cell metallic separator 1 of the first embodiment can be manufactured as below. As shown by an exemplified flow of manufacturing processes in FIG. 10, firstly, a passage P1 (FIG. 1B) is formed on a predetermined metallic plate 2 (S1), this metallic plate 2 is then set in a resin portion molding die (not shown) and the die is clamped, and a resin is injected into the resin portion molding die from a nozzle provided on the die, whereby the metallic plate 2 and a resin portion 3 are integrally formed to thereby prepare a metal-resin composite (S2). Next, this metal-resin composite is set in a seal material injection molding die M1 (FIG. 2) and a primer is applied to predetermined portions to thereby form a primer layer R1 (S3). Following this, a movable die half and a stationary die half of the seal material injection molding die M1 are clamped together, and a seal material is injected from nozzles N1 provided on the seal material injection molding die M1 to thereby form a rib portion Q1 (FIG. 1B) (S4). In the invention, the metallic plate 2 and the resin portion 3 are sealed and joined together at the same time as the rib portion Q1 is formed to thereby manufacture the fuel cell metallic separator 1 (FIG. 1A) according to the invention.

In addition, in the first embodiment according to the invention, as shown in FIG. 1B, the resin portion is formed in such a manner as to extend as far as both sides of the metallic plate 2 across an end face thereof. Namely, the resin portion 3 is formed in a U-shaped fashion so as to cover the end face of the metallic plate 2, whereby the resin portion 3 is made to adhere to the metallic plate 2 more strongly.

(Second Embodiment)

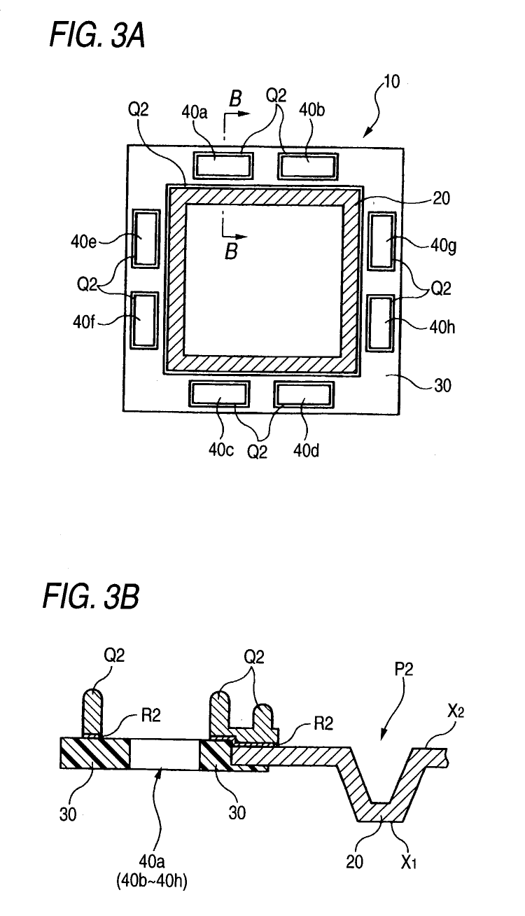

FIGS. 3A and 3B are typical drawings partially showing the construction of a fuel cell metallic separator according to a second embodiment of the invention, in which FIG. 3A is a plan view and FIG. 3B is a sectional view taken along the line B-B in FIG. 3A.

As shown in FIG. 3A, a fuel cell metallic separator 10 of the second embodiment according to the invention has a frame-like resin portion 30 made of a resin which is formed at upper and lower, and left and right edge portions of a metallic plate 20, and the metallic plate 20 and the resin portion 30 are formed integrally.

Then, as shown in FIG. 3B, the metallic plate 20 contained in the fuel cell metallic separator 10 according to the second embodiment is provided with a passage P2 for fuel gas, oxide gas or coolant for a fuel cell. In addition, as shown in FIG. 3A, the resin portion 30 is provided with communication ports 40a, 40b, 40c, 40d, 40e, 40f, 40g, 40h for allowing the fuel gas, oxide gas or coolant to pass therethrough.

In the second embodiment of the invention, as shown in FIG. 3B, openings in the resin portion 30 are formed in such a manner as to match the external configuration of the metallic plate 20, and a flange is provided to protrude from one side face of an edge of each opening so that the positioning of the metallic plate 20 can be implemented when it receives one side of the metallic plate 20, and the cross-sectional configuration of the side of the opening where the flange is formed is formed into a substantially L-shape.

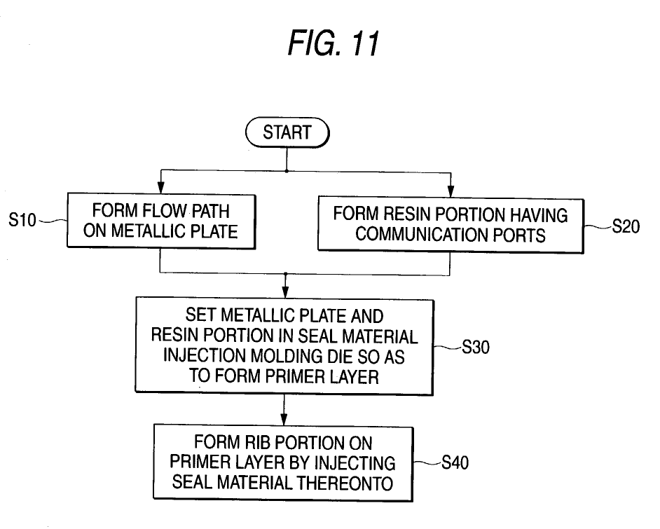

The fuel cell metallic separator 10 of the second embodiment can be manufactured as below. As shown by an exemplified flow of manufacturing processes in FIG. 11, firstly, a passage P2 (FIG. 3B) is formed on a predetermined metallic plate 20 (S10), while respective communication ports 40a to 40h are formed in a predetermined resin (for example, a resin in the form of sheet) (FIG. 3A), whereby a resin portion 30 is formed (S20). Next, the metallic plate 20 and the resin portion 30 are set in the seal material injection molding die M1 (FIG. 2) used in the first embodiment, so that a primer is applied to predetermined portions to thereby form a primer layer R2 (FIG. 3B) (S30). Following this, the movable die half and the stationary die half of the seal material injection molding die M1 are clamped together, and a seal material is injected, whereby a rib portion Q2 (FIGS. 3A, 3B) is formed. In the invention, as has been described above, the metallic plate 20 and the resin portion 30 are sealed and joined together at the same time as the rib portion Q2 is formed to thereby form a metal-resin composite.

In other words, in the invention, the metallic plate 20 (corresponding to the metallic plate 2 in FIG. 2) on which the passage P2 (FIG. 3B) is formed in advance and the resin portion 30 (corresponding to the resin portion 3 in FIG. 2) in which the respective communication ports 40a to 40h are formed in advance are set in a die similar to the seal material injection molding die M1 shown in FIG. 2. Then, the primer is applied at the predetermined portions of the metallic plate 20 and the resin portion 30 to form the primer layer R2. Following this, the seal material is injected from nozzles N1 provided on the seal material injection molding die M1 (FIG. 2) to thereby form the rib portion Q2, so that the metallic plate 20 and the resin portion 30 are sealed and joined together so as to be formed integrally at the same time as the rib portion Q2 is formed. Thus, the fuel cell metallic separator 10 (FIG. 3A) according to the invention can be manufactured through the above process.

(Third Embodiment)

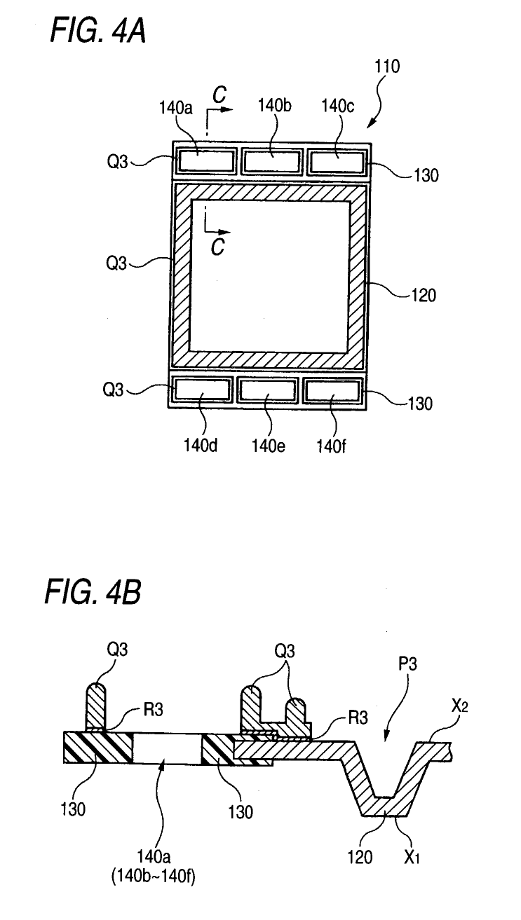

FIGS. 4A and 4B are typical drawings partially showing the construction of a fuel cell metallic separator according to a third embodiment of the invention, in which FIG. 4A is a plan view, and FIG. 4B is a sectional view taken along the line C-C in FIG. 4A.

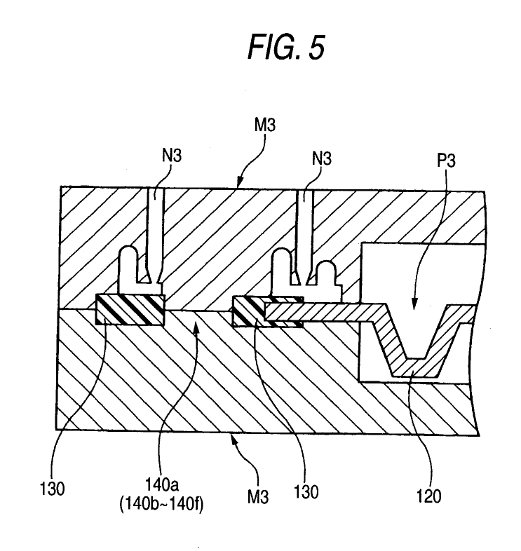

In addition, FIG. 5. is a schematic diagram showing a process of continuously forming a resin portion, and a primary layer and a rib portion which constitute an airtight seal among manufacturing processes of the fuel cell metallic separator of the third embodiment according to the invention.

As shown in FIG. 4A, in the fuel cell metallic separator 110 of the third embodiment according to the invention, two independent resin portions 130 made of a resin are formed at upper and lower edge portions of a metallic plate 120, whereby the metallic plate 120 and the resin portions 130 are formed integrally.

In addition, as shown in the FIG. 4B, the metallic plate 120 contained in the fuel cell metallic separator 110 of the third embodiment is provided with a passage P3 for fuel gas, oxide gas or coolant for a fuel cell. As shown in FIG. 4A, the resin portion 130 is provided with respective communication ports 140a, 140b, 140c, 140d, 140e, 140f for allowing the fuel gas, oxide gas or coolant to pass therethrough.

Then, the fuel cell metallic separator according to the third embodiment can be manufactured as below. As shown by the exemplified flow in FIG. 10, firstly, a passage P3 is formed on a predetermined metallic plate 120 (S1), the metallic plate 120 is then set in a resin portion molding die (not shown), the die is clamped, and a resin is injected from a nozzle provided on the resin portion molding die to upper and lower edge portions of the metallic plate 120, whereby the metallic plate 120 and the resin portions 130 are formed integrally to thereby prepare a metal-resin composite (S2). Next, this metal-resin composite is set in a seal material injection molding die M3 (FIG. 5), and a primer is applied to predetermined portions to thereby form a primer layer R3 (S3). Following this, a movable die half and a stationary die half of the seal material injection molding die M3 are clamped together, and the seal material is injected from nozzles N3 to form a rib portion Q3 (S4) Note that as shown in FIG. 4B, in the third embodiment of the invention, the resin portions 130 are each formed in such a manner as to extend as far as sides of the metallic plate 120 accross an end face thereof. In other words, the resin portions 130 are each formed into a U-shape in such a manner as to cover the end face of the metallic plate 120, whereby the resin portions 130 are caused to adhere to the metallic plate 120 strongly.

In the fuel cell metallic separator 110 of the third embodiment according to the invention which is constructed as has been described above, since the two independent resin portions 130 are provided at the upper and lower edge portions of the metallic plate 120, the size of the fuel cell metallic separator 110 can be made smaller than the first embodiment in which the frame-like resin portion 3 is provided at the upper and lower, and left and right edge portions of the metallic plate 2 or the second embodiment in which the frame-like resin portion 30 is provided at the upper and lower, and left and right edge portions of the metallic plate 120.

(Fourth Embodiment)

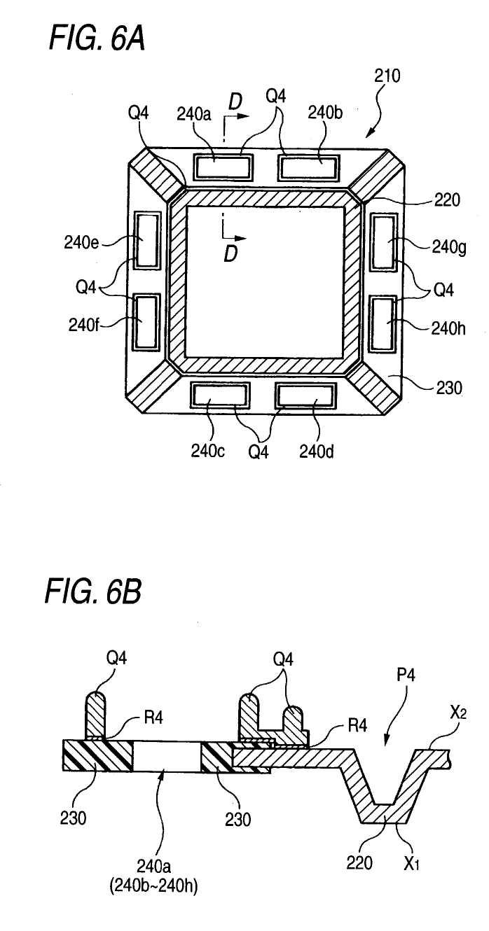

FIGS. 6A and 6B are typical drawings partially showing the construction of a fuel cell metallic separator of a fourth embodiment according to the invention, in which FIG. 6A is a plan view, and FIG. 6B is a sectional view taken along the line D-D in FIG. 6A.

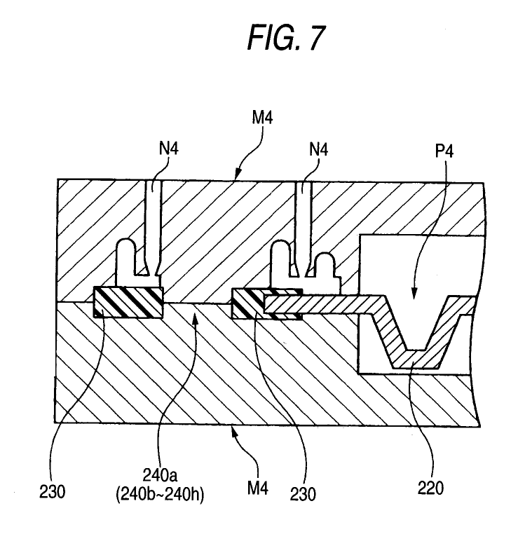

In addition, FIG. 7 is a schematic diagram showing a process of continuously forming a resin portion, and a primer layer and a rib portion which constitute an airtight seal among manufacturing processes of the fuel cell metallic separator of the fourth embodiment.

In the fuel cell metallic separator 210 of the fourth embodiment according to the invention, as shown in FIG. 6A, resin portions 230 which are constituted by four independent portions are formed at upper and lower, and left and right edge portions of a predetermined metallic plate 220, the metallic plate 220 is formed in such a manner as to extend diagonally from the respective apexes thereof toward respective apexes of the fuel cell metallic separator 210, and furthermore, the metallic plate and the resin portions 230 are formed integrally.

Then, as shown in FIG. 6B, the metallic plate 220 contained in the fuel cell metallic separator 210 of the fourth embodiment is provided with a passage P4 for fuel gas, oxide gas or coolant for a fuel cell. In addition, as shown in FIG. 6A, the resin portions 230 are provided with respective communication ports 240a, 240b, 240c, 240d, 240e, 240f, 240g, 240h for allowing the fuel gas, oxide gas or coolant to pass therethrough.

Then, the fuel cell metallic separator of the fourth embodiment can be manufactured as below. As shown by the exemplified flow of manufacturing processes in FIG. 10, firstly, a passage P4 (FIG. 6B) is formed on a predetermined metallic plate 220 (S1), this metallic plate 220 is set in a resin portion molding die (not shown) and the die is clamped, and a resin is injected from a nozzle provided on the resin portion molding die, whereby the metallic plate 220 and the resin portions 230 are formed integrally to thereby prepare a metal-resin composite (S2). Next, this metal-resin composite is set in a seal material injection molding die M4 (FIG. 7) and a primer is applied to predetermined portions to thereby form a primer layer R4 (S3). Following this, a movable die half and a stationary die half of the seal material injection molding die M4 are clamped together, and a seal material is injected from nozzles N4 provided on the seal material injection molding die M4 to thereby form a rib portion Q4 (refer to FIG. 6B) (S4) In the invention, as has been described, the metallic plate 220 and the resin portions 230 are sealed and joined together to thereby form the metal-resin composite at the same time as the rib portion Q4 is formed, whereby the fuel cell metallic separator 210 (FIG. 6A) according to the invention can be formed.

In the fuel cell metallic separator 210 of the fourth embodiment according to the invention that is constructed as has been described above, as shown in FIG. 6B, since the resin portion 230 is extended as far as sides of the metallic plate 220 across an end face thereof, the resin portion 230 is formed in a U-shape in such a manner as to cover the end face of the metallic plate 220, whereby the resin portion 230 is made to adhere to the metallic plate 220 strongly. Furthermore, the metallic plate 220 extends in the diagonal directions of the fuel cell metallic separator 210 from the metallic plate 220, and the upper and lower, and left and right edge portions of the metallic plate 220 are constructed as the resin portions 230 constituted by the four independent portions. As a result, the fuel cell metallic separator 210 of the fourth embodiment becomes a fuel cell metallic separator having a relatively high rigidity.

(Fifth Embodiment)

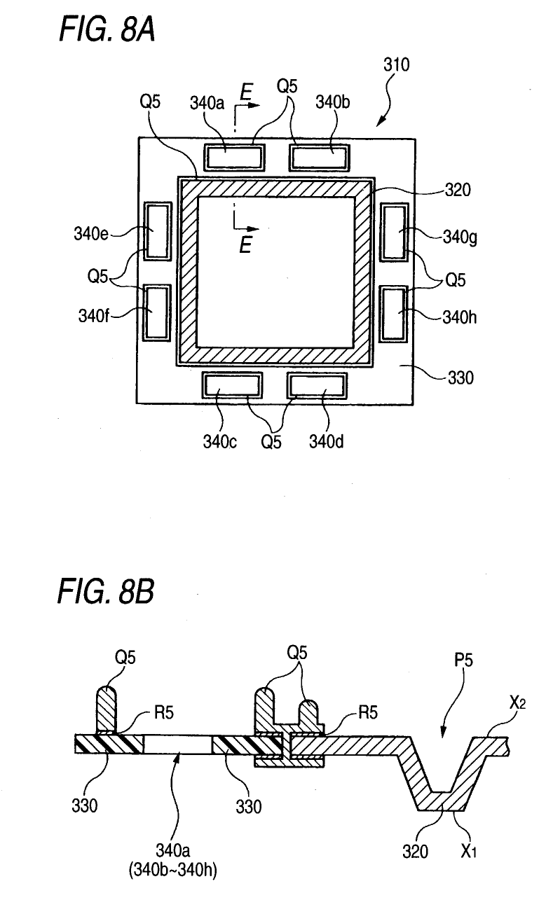

FIGS. 8A and 8B are schematic drawings partially showing the construction of a fuel cell metallic separator of a fifth embodiment according to the invention, in which FIG. 8A is a plan view, and FIG. 8B is a sectional view taken along the line E-E in FIG. 8A.

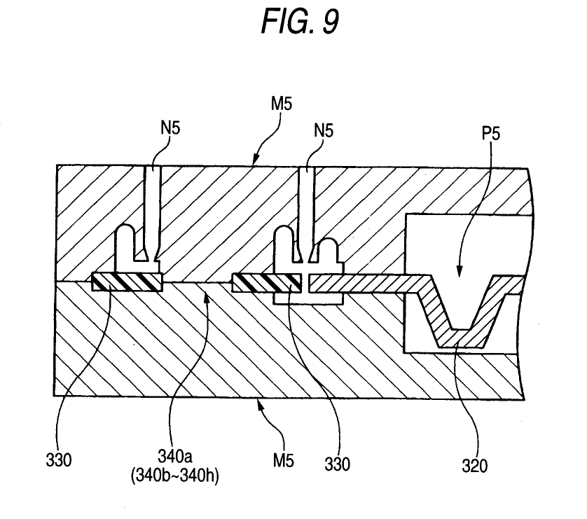

In addition, FIG. 9 is a schematic diagram showing a process of continuously forming a resin portion, and a primer layer and a rib portion which constitute an airtight seal.

In the fuel cell metallic separator 310 of the fifth embodiment according to the invention, as shown in FIG. 8A, a frame-like resin portion 330 made of a resin is formed at upper and lower, and left and right edge portions of a metallic plate 320, and the metallic plate 320 and the resin portion 330 are formed integrally.

As shown in FIG. 8B, the metallic plate 320 contained in the fuel cell metallic separator 310 of the fifth embodiment is provided with a passage P5 for fuel gas, oxide gas or coolant for a fuel cell. Then, as shown in FIG. 8A, the resin portion 330 is provided with respective communication ports 340a, 340b, 340c, 340d, 340e, 340f, 340g, 340h for allowing the fuel gas, oxide gas or coolant to pass therethrough. Furthermore, as shown in FIG. 8B, a rib portion Q5 is formed integrally with the metallic plate 320 and the resin portion 330 in such a manner as to be interposed therebetween. In the invention, the leakage of fuel gas, oxide gas or coolant is prevented to an extreme level by interposing the rib portion made of a seal material between the metallic plate and the resin portion as has been described above to thereby join and form integrally the metallic plate and the resin portion.

Then, the fuel cell metallic separator 310 of the fifth embodiment can be manufactured as below. As shown by the exemplified flow of manufacturing processes in FIG. 11, firstly, a passage P5 (FIG. 8B) is formed on a predetermined metallic plate 320 (S10), while respective communication ports 340a to 340h (FIGS. 8A, 8B) are provided in a predetermined resin (for example, a sheet of resin) to thereby form a resin portion (S20). Next, the metallic plate 320 and the resin portion 330 are set in a seal material injection molding die M5 (FIG. 9), and a primer is applied to predetermined portions to thereby form a primer layer R5 (FIG. 8B) (S30). Following this, a rib portion Q5 (FIG. 8B) is formed by clamping a movable die half and a stationary die half of the seal material injection molding die M5 and injecting a seal material thereinto (S40). In this invention, the metallic plate 320 and the resin portion 330 are sealed 10 and joined together at the same time as the rig portion Q5 is formed as has been described above, whereby the fuel cell metallic separator 310 according to the invention can be manufactured.

Note that according to the fifth embodiment of the invention, as shown in FIG. 8B, the metallic plate 320 and the resin portion 330 are joined together to thereby formed integrally with the seal material (or both the seal material and the primer layer R5) being interposed therebetween.

Thus, while the preferred embodiments of the invention have been described heretofore, the invention is not limited to the embodiments but may be modified appropriately as long as the modifications are based upon the technical concept of the invention. For example, the shape of the fuel cell metallic separator of according to the invention may be formed substantially into a circular shape, the resin portion may be constructed to be formed on part of edge portions of a substantially circular metallic plate.

### EXAMPLES

Next, Examples 1 to 5 according to the invention will be described referring to the accompanying drawings.

In the following examples 1 to 5, 20 kinds of fuel cell metallic separators are prepared with an “n” number being 300 for each example by using five kinds of metallic plates (1050 aluminum (JIS H 4000), 5000 system aluminum alloy (JIS H 4100) of Al—Mg system, SUS316 (JIS G 4309), SPCC (JIS G 3141), or JIS second class pure titanium) and four kinds of resin portions (phenolic resin and epoxy resin which are thermosetting resins, or polyphenylene sulfide (PPS) which is thermoplastic resin and liquid crystal polymer). In addition, in any of the following examples 1 to 5, a silicone primer (two-part, mixing type) commercially available from Shinetsu Silicone as a primer, and a silicone rubber is used as a seal material. The injection pressure for the silicone rubber is set to 17 MPa and the temperature of the seal material injection molding die for use in forming the rib portion is set at 200° C. for preparation of fuel cell metallic separators.

Note that metal plating is applied to the surface of the SPCC in advance in order not to interrupt the conductivity, whereby a desired corrosion resistance is imparted.

### (Example 1)

As shown in FIG. 1, in Example 1 according to the invention, a fuel cell metallic separator 1 is constructed in which a resin portion 3 is formed on upper and lower, and left and right peripheral edge portions of a metallic plate 2 in a frame-like fashion in such a manner as to overlap part of the edge portions of the metallic plate 2. Then, as shown in FIG. 1B, formed on the metallic plate 2 is a passage P1 for fuel gas, oxide gas or coolant, and as shown in FIGS. 1A, 1B, formed in the resin portion 3 are communication ports 4a, 4b, 4c, 4d, 4f, 4g, 4h for allowing fuel gas, oxide gas or coolant to pass therethrough. Furthermore, as shown in FIG. 1B, the resin portion 3 is formed into a U-shape to thereby extend as far as sides of the metallic plate 2 across an end face thereof so as to cover the end face of the metallic plate 2, whereby the resin portion 3 is made to adhere to the metallic plate 2 more strongly.

The fuel cell metallic separator 1 of Example 1 is such as to be prepared following the exemplified flow 20 of processes shown in FIG. 10. Namely, firstly, the metallic plate 2 is pressed to form the passage PI (FIG. 1B) for the fuel gas, oxide gas or coolant (SI), following this, the metallic plate 2 is set in a resin portion molding die (not shown) and the die is clamped, and a resin is injected from a nozzle provided on the resin portion molding die, whereby the metallic plate 2 and the resin portion 3 are formed integrally to thereby form a metal-resin composite (S2). Next, this metal-resin composite is set in a seal material injection molding die M1 (FIG. 2) and a primer is applied to portions of the metallic plate 2 and the resin portion 3 to which seal material is applied to thereby form a primer layer R1 (FIG. 1B) (S3). Following this, a movable die half and a stationary die half of the seal material injection molding die M1 are clamped together and a seal material is injected from nozzles N1 provided on the seal material injection molding die M1 to thereby form a rib portion Q1 (FIG. 1B) on the primer layer R1 (S4), whereby the fuel cell metallic separator 1 is prepared in which the metallic plate 2 and the resin portion 3 are formed integrally.

### (Example 2)

In Example 2 of the invention, as shown in FIGS. 3A and 3B, a fuel cell metallic separator 10 is constructed in which a resin portion 30 is integrally formed in a frame-like fashion on upper and lower, and left and right peripheral edge portions of a metallic plate 20 in such a manner as to overlap part of the edge portions of the metallic plate 20. Then, as shown in FIG. 3B, a passage P2 is formed on the metallic plate 20 for fuel gas, oxide gas or coolant, and as shown in FIGS. 3A, 3B, communication ports 40a, 40b, 40c, 40d, 40e, 40f, 40g, 40h are formed in the resin portion 30 for allowing fuel gas, oxide gas or coolant to pass therethrough. Furthermore, as shown in FIG. 3B, the openings are formed in the resin portion 30 in such a manner as to match the external shape of the metallic plate 20, and a flange is provided to protrude from one side of an edge of each opening in the resin portion so as to position the metallic plate 20 when one side of the metallic plate is received by the flange. The portion where the flange is provided has an L-shaped cross section.

The fuel cell metallic separator 10 of Example 2 is prepared in accordance with the exemplified flow of processes shown in FIG. 11. Namely, firstly, the metallic plate 20 is pressed to form the passage P2 (FIG. 3B) for the fuel gas, oxide gas or coolant (S10), while the communication ports 40a to 40h (FIGS. 3A, 3B) are formed in a sheet resin to thereby form the resin portion 30 (S20). Next, the metallic plate 20 and the resin portion 30 so prepared are then set in the seal material injection molding die M1 (FIG. 2) which is used in preparing the fuel cell metallic separator according to Example 1 and a primer is applied to portions of the metallic plate 20 and the resin portion 30 to which the seal material is applied to thereby form a primer layer R2 (FIG. 3B) (S30). Following this, the movable die half and the stationary die half of the seal material injection molding die M1 are clamped together, and the seal material is injected from the nozzles N1 provided on the seal material injection molding die M1 to thereby form a rib portion Q2 (FIG. 3B) on the primer layer R2 (S40), whereby the fuel cell metallic separator 10 is prepared in which the metallic plate 20 and the resin portion 30 are formed integrally.

### (Example 3)

In Example 3 of the invention, as shown in FIGS. 4A and 4B, a fuel cell metallic separator 110 is constructed in which two independent resin portions 130 are integrally formed on upper and lower peripheral edge portions of a metallic plate 120 in such a manner as to overlap part of the edge portions of the metallic plate 120. Then, as shown in FIG. 4B, a passage P3 is formed on the metallic plate 120 for fuel gas, oxide gas or coolant. Additionally, as shown in FIGS. 4A, 4B, communication ports 140a, 140b, 140c, 140d, 140e, 140f are formed in the resin portion 130 for allowing fuel gas, oxide gas or coolant to pass therethrough. Furthermore, as shown in FIG. 4B, the resin portion 130 is formed in such a manner as to extend as far as sides of the metallic plate 120 across an end face 20 thereof. Namely, the resin portion 130 is formed into a U-shape so as to cover the end face of the metallic plate 120, whereby the resin portion 130 is made to adhere to the metallic plate 120 strongly.

The fuel cell metallic separator 110 of Example 3 is such as to be prepared in accordance with the exemplified flow of process shown in FIG. 10. Namely, firstly, the metallic plate 120 is pressed to form the passage P3 (FIG. 4B) for the fuel gas, oxide gas or coolant with a view to provide a certain corrosion resistance (S1), and following this, the metallic plate 120 is set in the resin portion molding die (not shown) and the die is clamped, and the resin is injected from the nozzle provided on the resin portion molding die for forming the resin portion, whereby the metallic plate 120 and the resin portion 130 are formed integrally to thereby prepare a metal resin composite (S2) Next, this metal resin composite is then set in a seal material injection molding die M3 (FIG. 5) and a primer is applied to portions of the metallic plate 120 and the resin portion 130 to which the seal material is applied to thereby form a primer layer R3 (S3). Following this, a movable die half and a stationary die half of the seal material injection molding die M3 are clamped together and the seal material is injected from nozzles N3 provided on the seal material injection molding die M3 to thereby form a rib portion Q3 (FIG. 4B) on the primer layer R3 (S4), whereby the fuel cell metallic separator 110 is prepared in which the metallic plate 120 and the resin portion 130 are formed integrally.

### (Example 4)

In Example 4 according to the invention, as shown in FIGS. 6A and 6B, a fuel cell metallic separator 210 is constructed in which a metallic plate 220 is formed in such a manner as to extend in diagonal directions extending from respective apexes of the metallic plate 220 to respective apexes of the fuel cell metallic separator 210, and four independent resin portions 230 are integrally formed on upper and lower, and left and right peripheral edge portions of the metallic plate 220 in such a manner as to overlap part of the edge portions of the metallic plate 220. Then, as shown in FIG. 6B, a passage P4 is formed on the metallic plate 220 for fuel gas, oxide gas or coolant. In addition, formed in the resin portions 230 are communication ports 240a, 240b, 240c, 240d, 240e, 240f, 240f, 240h for allowing fuel gas, oxide gas or coolant to pass therethrough. Furthermore, as shown in FIG. 6B, the resin portion 230 is formed in such a manner as to extend across an end face of the metallic plate 220 to extend as far as sides of the metallic plate 220. Namely, the resin portion 230 is formed into a U-shape so as to cover the end face of the metallic plate 220, whereby the resin portion 230 is allowed to adhere to the metallic plate 220 strongly.

The fuel cell metallic separator 210 of Example 4 is such as to be prepared in accordance with the exemplified flow of processes shown in FIG. 10. Namely, firstly, the metallic plate 220 is pressed to form the passage P4 (FIG. 6B) for the fuel gas, oxide gas or coolant (S1), and following this, the metallic plate 220 is set in the resin portion molding die (not shown) and the die is clamped, and the resin for forming a resin portion is injected from the nozzle provided on the resin portion molding die, where by the metallic plate 220 and the resin portions 230 are integrally formed to thereby prepare a metal-resin composite (S2). Next, the metal-resin composite is set in a seal material injection molding die M4 (FIG. 7) and a primer is applied to predetermined portions of the metallic plate 220 and the resin portions 230 to which the seal material is applied to thereby form a primer layer R4 (S3). Following this, a movable die half and a stationary die half of the seal material injection molding die M4 (FIG. 6B) are clamped together and the seal material is injected from nozzles N4 provided on the seal material injection molding die M4 to thereby form a rib portion Q4 (FIG. 6B) on the primer layer R4 (S4), whereby the fuel cell metallic separator 210 is prepared in which the metallic plate 220 and the resin portions 230 are formed integrally.

With the fuel cell metallic separator 210 of Example 4 according to the invention, as shown in FIG. 6B, since the resin portions 230 are each formed so as to extend as far as sides of the metallic plate 220 across an end face thereof, the resin portions 230 are each formed into a U-shape so as to cover the end face of the metallic plate 220 and are each made to adhere to the metallic plate 220 strongly. Furthermore, the metallic plate 220 extends in the diagonal directions of the fuel cell metallic separator 210 from the metallic plate 220, and the upper and lower, and left and right edge portions of the metallic plate 220 are formed as the resin portions 230 including the four portions which are independent from each other. As a result, the fuel cell metallic separator 210 of Example 4 has a higher rigidity than those of Examples 1 to 3.

### (Example 5)

In Example 5 according to the invention, as shown in FIGS. 8A and 8B, a fuel cell metallic separator 310 is constructed in which a resin portion 330 is formed integrally in a frame-like fashion on upper and lower, and left and right peripheral edge portions of a metallic plate 320 with a rib portion Q5 made of a seal material being interposed between the resin portion 330 and the metallic plate 320. Then, as shown in FIG. 8B, a passage P5 is formed on the metallic plate 320 for fuel gas, oxide gas or coolant. In addition, formed in the resin portion 330 are communication ports 340a, 340b, 340c, 340d, 340e, 340f, 340g, 340h for allowing fuel gas, oxide gas or coolant to pass therethrogh.

The fuel cell metallic separator 310 of Example 5 is such as to be prepared in accordance with the exemplified flow of processes shown in FIG. 11. Namely, firstly, as shown in FIGS. 8A and 8B, the metallic plate 320 is pressed to form the passage P5 (FIG. 8B) for the fuel gas, oxide gas or coolant (S10), while the respective communication ports 340a to 340h (FIGS. 8A, 8B) are formed in a resin sheet to thereby form the resin portion 330 (S20). Next, the metallic plate 320 and the resin portion 330 so formed are set in a seal material injection molding die MS (FIG. 9) and a primer is applied to portions of the metallic plate 320 and the resin portion 330 to thereby form a primer layer R5 (FIG. 8B) (S30). Following this, a movable die half and a stationary die half of the seal material injection molding die M5 are clamped together, and the seal material is injected from nozzles N5 provided on the seal material injection molding die M5 to thereby form a rib portion Q5 (FIG. 8B) on the primer layer R5 (S40), whereby the fuel cell metallic separator 310 is prepared in which the metallic plate 320 and the resin portion 330 are formed integrally.

Thus, in any of the fuel cell metallic separators of Examples 1 to 5 according to the invention, since at least either the upper and lower edge portions or the left and right edge portions of the metallic plate are formed integrally with the resin portions made of resin in such a manner that the resin portions overlap part of the edge portions of the metallic plate or with the seal material being interposed between the resin portion and the metallic plate, and since the communication ports are formed in the resin portions for allowing fuel gas, oxide gas or coolant to pass therethrough, even if water stays in the communication ports, it is possible to prevent the occurrence of a short-circuit between the structure supporting the fuel cell and the metallic plate via water so staying, and as a result, it is confirmed that the electrolytic corrosion of the metallic plate can be prevented to an extreme level, thereby making it possible to provide superior corrosion resistance.

Then, the fuel cell metallic separators according to Examples 1 to 5 of the invention were applied to fuel cells for testing. It was verified that any of the fuel cell metallic separators exhibited a durability equal to or better than those of conventional fuel cell metallic separators in which the carbon material or stainless steel or titanium metallic material is solely used. In addition, the production costs of the fuel cell metallic separators according to Examples 1 to 5 were suppressed to a lower level than those of the conventional fuel cell metallic separators, and the former metallic separators are thinner than the latter metallic separators, whereby there can be provided an advantage that the size of the stacked structure of a fuel cell stack and hence the size of the main body of a fuel cell stack using the fuel cell metallic separators of the invention can be reduced 10 to 20% smaller than those of the stacked structure of the conventional fuel cell stacks or the main body of the conventional fuel cell stacks.

Note that the invention is not limited to the Examples described heretofore but may be modified variously as long as the modifications are based on the technical concept of the invention. For example, as to the forms of the resin portions of the fuel cell metallic separators according to the invention, in addition to the frame-like configuration and those in which the resin portion is divided into two or four independent portions, various configurations can be adopted as required.

What is claimed is:

1. A fuel cell metallic separator adapted to constitute a partition wall between single cells of a fuel cell stack, comprising:
a metallic plate; and
a resin portion made of a resin integrally formed on said metallic plate in such a manner as to overlap at least part of edge portions of said metallic plate, said resin portion having at least one communication port for allowing fuel gas, oxide gas or coolant to pass therethrough for communication between said single cells.

2. The fuel cell metallic separator according to claim 1, further comprising:
a rib portion made of a seal material and formed around said communication port provided in said resin portion through injection molding.

3. The fuel cell metallic separator according to claim 1, wherein said resin portion is made of a thermoplastic resin.

4. The fuel cell metallic separator according to claim 1, wherein said resin portion is made of a polyphenylene sulfide or a liquid crystal polymer.

5. The fuel cell metallic separator according to claim 1, wherein said resin portion is made of a thermosetting resin.

6. The fuel cell metallic separator according to claim 1, wherein said resin portion is made of a phenolic resin or an epoxy resin.

7. A fuel cell metallic-separator adapted to constitute a partition wall between single cells of a fuel cell stack, comprising:
a metallic plate; and
a resin portion made of a resin integrally formed on said metallic plate in such a manner that a sealing member is interposed therebetween, said resin portion having at least one communication port for allowing fuel gas, oxide gas or coolant to pass therethrough for communication between said single cells.

8. The fuel cell metallic separator according to claim 7, further comprising:
a rib portion made of a seal material and formed around said communication port provided in said resin portion through injection molding.

9. The fuel cell metallic separator according to claim 7, wherein said resin portion is made of a thermoplastic resin.

10. The fuel cell metallic separator according to claim 7, wherein said resin portion is made of a polyphenylene sulfide or a liquid crystal polymer.

11. The fuel cell metallic separator according to claim 7, wherein said resin portion is made of a thermosetting resin.

12. The fuel cell metallic separator according to claim 7, wherein said resin portion is made of a phenolic resin or an epoxy resin.

13. A method for manufacturing said fuel cell metallic separator according to claim 2, comprising the steps of;
(a1) setting said metallic plate in a resin portion molding die, and injecting the resin into said die so as to integrally form said resin portion having said communication port on said metallic plate to thereby form a metal-resin composite plate;
(a2) applying a resin for forming a primer layer around said communication port in said metal-resin composite plate so as to form the primer layer; and
(a3) setting said metal-resin composite plate on which said primer layer is formed in a rib molding die and injecting said seal material on said primer layer so as to form said rib portion.

14. The method according to claim 13, wherein said resin portion is made of a thermoplastic resin.

15. The method according to claims 13, wherein said resin portion is made of a polyphenylene sulfide or a liquid crystal polymer.

16. The method according to claim 13, wherein said resin portion is formed of a thermosetting resin.

17. The method according to claim 13, wherein said resin portion is formed of a phenolic resin or an epoxy resin.

18. The method for manufacturing a fuel cell metallic separator according to claim 2, comprising the steps of;
(b1) forming said resin portion having said communicating port; and
(b2) setting said metallic plate and said resin portion in a seal molding die in such a manner that said at least part of edge portions of said metallic plate overlap said resin portion and injecting the seal material so as to form said rib portion while sealing and joining a portion where said at least part of edge portions of said metallic plate and said resin portion overlap each other.

19. The method according to claim 18, wherein said resin portion is made of a thermoplastic resin.

20. The method according to claim 18, wherein said resin portion is made of a polypenylene sulfide or a liquid crystal polymer.

21. The method according to claim 18, wherein said resin portion is made of a thermosetting resin.

22. The method according to claim 18, wherein said resin portion is made of a phenolic resin or an epoxy resin.

23. The method for manufacturing a fuel cell metallic separator according to claim 8, comprising the steps of;
(c1) forming a resin portion having said communicating port; and
(c2) setting said metallic plate and said resin portion side by side in a seal molding die in such a manner that said metallic plate and said resin portion form a gap therebetween and injecting the seal material so as to form said rib portion as well as the sealing member interposed between said metallic plate and said resin portion.
